(19) United States
(12) Patent Application Publication
(10) Pub. No.: US 2024/0297867 A1
(43) Pub. Date: Sep. 5, 2024

(54) INTERACTIVE SOCIAL ICEBREAKER

(71) Applicant: Jade C. Johnson, Brooklyn, NY (US)

(72) Inventor: Jade C. Johnson, Brooklyn, NY (US)

(21) Appl. No.: 18/116,529

(22) Filed: Mar. 2, 2023

(51) Int. Cl. H04L 51/52; G06Q 50/00

(52) U.S. Cl. CPC H04L 51/52; G06Q 50/01

(57) ABSTRACT

The following disclosure relates to a computer implemented method of facilitating social activity by providing users the ability to communicate and interact more quickly and comfortably in a fun space using similarities while at the same time recognizing beauty in differences. The method provides greater insight and a deeper understanding of who a user is through a set of questions pertaining to a certain module (i.e., creating a fun social activity). The results from the set of questions may be used to facilitate a connection between users, as opposed to identifying just topical interests in common with another user discovered through user profiles. Specifically, the method includes prompting, by a processor, at least one message to the one or more users for developing content-rich conversations between the one or more users based on the results from the set of questions.

### FIELD

The following disclosure relates to a system and method for facilitating social activity, more particularly, to a system and method for facilitating a connection between users via a structured communication session.

### BACKGROUND

Our society has transformed heavily in recent years, relying mostly on the internet to communicate, work, meet, and connect with others. With the rise of smartphones and the ever-evolving internet, communication networks have rapidly progressed to connect people from across the globe. However, even with so many advances in communication, the ability to communicate and interact quickly and comfortably in a space that creates fun with similarities while also recognizing the beauty in differences remains unseen.

Many platforms have been created, such as social networks, messengers, dating applications, and the like, to communicate and enable people to socialize.

A social network is a network of social interactions and personal relationships and may refer to a community of members, participants, users or other individuals that share similar values or interests. Each member is typically associated with a personal profile, which may contain demographics, psychographics or professional information relating to the user. Each member may have from zero to many connections or relationships with other members within the social network. Each member may engage in activities, such as e-mail communications, information sharing, etc., with other members. These individuals may grow the social network community by inviting others to join/connect to their community. A social network may also include individuals who engage in some common real-time activities online and share some common context. This includes, but is not limited to, shopping at the same online e-merchant website, browsing the same or related content pages, or engaging in an online event or activities at the same time. A social network may extend to activities, and individuals engaging in activities, through a dedicated website or other application that enables users to communicate with each other by posting information, messages, images, comments, and the like. For example, social networks such as Instagram enable users to actively take photos of their lives (e.g., activities ranging from sports, cooking, traveling, and the like) and share their photos or activities with each other through a webpage, application, or another platform. Thus, users can actively track what other users do and connect based on similar interests, viewpoints, sports, ideas, and the like. Such social networks may include Pinterest, Tumblr, Snapchat, TikTok, YouTube, and the like. As used herein, the term “users” may include members, guest members, and others participating in a social environment, and the term “social” is used in broadest sense to refer to communities of interest.

A social networking service is an electronic or otherwise online/network-based service that provides a platform for, or otherwise facilitates, creating and/or building social networks and/or relationships among people who share interests. Generally, users are required to create a profile of themselves by filling out specific information (e.g., physical attributes, beliefs, goals, etc.). The information provided by the user is then accessible to view by other users using the same platform. Users can decide to connect with each other based on the available information, allowing the connected users to communicate or otherwise interact with one another.

Further, a social networking service may include applications which implement forums, where the user may communicate with other users. The user may be able to create and/or subscribe to groups that share common interests or affiliations, and the user may be able to send or receive comments and other content to or from the other group members. The social networking service may provide controls that allow the user to determine which other users may view the user profile or contact the user, and to which users profile changes or updates are reported or pushed. However, such connections have drawbacks. For instance, establishing connections between users may be detrimental to user privacy, as the information pertaining to the user is mostly accessible by other users. Therefore, users may not disclose all relevant information, hindering the potential for a strong connection. Moreover, user representation based on the aggregation of information provided by the users is only as good as the information provided by the users. Users who do not take the time to provide sufficient information about themselves create another problem of having a static and a monolithic image of the user, which restricts creating connections since a user's information cannot keep up with the dynamics and alterations of a user's personality and beliefs. Further, a user's representation is essentially a screenshot, with little or no explanation about the user's personality or beliefs.

In addition, a majority of these social networking services require establishing a connection between two users to enable interaction, with the underlying assumption that a strong connection will automatically occur due to any interaction. However, such an assumption may prompt the users to connect merely with the intention of the interaction, skipping the need for an in-depth understanding of the user's personality and beliefs. Such an assumption requires any interaction without substantive information, creating restricted or defective connections between users. Often, users may tend to have unstructured or unproductive conversations due to a lack of understanding of the personalities and beliefs of the connected users, thus missing out on a connection or failing to truly understand one another.

Further, social networking services, such as dating applications and the like, may exclusively focus on dating or creating amorous relations while putting aside other types of connections. As such, these platforms mostly function as matchmaking intermediaries acting on a restricted purpose (i.e., romantic relations). These platforms cannot fulfill the need for the sense of randomness of real-life human interaction, where a connection can spark even from the most random encounters with unsuspecting people with different views. Additionally, these platforms are not broad enough to be applied in various scenarios, such as work-related events, icebreaker activities, platonic relationships, and the like.

Furthermore, social networking services assist in creating connections between users only based on an existing connection, as mentioned above. For instance, a user might be more willing to reach out or connect to another user, if the user understands that the other user has a connection with someone the user knows. Thus, creating connections with other users is daunting if the user lacks one such connection. As a result, the user may be forced to adopt unreliable attempts that are audacious to create connections with other users. These unreliable attempts may warn other users against connecting with that user as other users consider only the profile data prior to attempting the connection.

An icebreaker is another form of a social networking activity. An icebreaker refers to an activity, game, or interaction that can be used to welcome and facilitate relationships between participants who may be meeting for the first time, such as in meetings, training sessions or other similar events. Icebreakers are predominantly utilized at the initial (forming) stage of group development to relieve inhibitions or tension between people so that everyone may feel more relaxed together. For example, icebreakers play a pivotal role in individuals forming into groups by: helping participants get acquainted with each other and the facilitators; increasing communication and equal participation of all group members; helping participants feeling more at ease; and bonding quickly, therefore facilitating working towards common goals. However, if done incorrectly, an icebreaker can have damaging and lasting effects on group learning and behavior in any given session.

Thus, in existing social networking services and activities, a connection is made between users where the conversation conducted is fruitless and often confusing and misunderstood—leaving the users to wonder why the initial connection failed. Furthermore, the existing social networking services and activities fail to be broad enough to encompass all connections (e.g., work, networking, romantic, friends, and the like). Even if the existing social networking services and activities do create connections, the connections can have damaging and lasting effects on the users if done incorrectly and poorly facilitated. Lastly, existing platforms fail to break through perceived differences to foster commonalities, communication, and create a deeper connection between users.

### SUMMARY

In one embodiment, a computer implemented method of facilitating social activity includes: providing, by a processor through a graphical user interface (GUI), a first set of questions to a user of one or more users based on a selected module, the first set of questions provided to the user of the one or more users; receiving, by the processor through the GUI, responses to the first set of questions from the user of the one or more users; and calculating, by the processor, a composite score for the user of the one or more users based on the received responses. The method further includes: generating, by the processor, a personality type for the user of the one or more users based on the calculated composite score; providing, by the processor through the GUI, the calculated composite score and the generated personality type to the user of the one or more users; and prompting, by the processor, at least one message to the one or more users for developing content-rich conversations between the one or more users.

In another embodiment the method may further include comparing, by the processor, the calculated composite score and the generated personality type of the user with a composite score and a personality type of another user of the one more users. The composite score and the personality type of the other user may be calculated and generated based on the responses by the other user to the first set of questions. The method may further include: comparing, by the processor, the responses to the first set of questions between the user and the other user of the one or more users; and generating, by the processor, a summary of the comparisons of the respective composite scores, personality types, and responses based on the first set of questions between the user and the other user of the one or more users. Furthermore, the method may include: transmitting, by the processor, the summary to the user and the other user of the one or more users; and storing, by the processor, the transmitted summary to a database. The transmitted summary may be associated with the user and the other user of the one or more users.

In another embodiment, the method may further include displaying, by the GUI, a first message and a second message to the user of the one or more users. The first message relates to the responses to the first set of questions, the calculated composite score based on the first set of questions, and the generated personality type. The first message provides the user of the one or more users information regarding what each composite score and personality type mean. The second message relates to the transmitted summary and highlights similarities in the transmitted summary.

In another embodiment, the method may further include: initiating, by the processor, a communication session between the user and the other user of the one or more users. The communication session allows for interaction between the user and the other user.

In another embodiment, the communication session may be performed in real-time.

In another embodiment, the method may further include providing, by the processor, a second set of questions to the user of the one or more users. The second set of questions may be related to the received responses to the first set of questions. The communication session may be prompted by the second set of questions to help the user and the other user of the one or more users to understand the respective scores, personality types, and responses to the first set of questions.

In another embodiment, the method may further include storing, in a database by the processor, a user profile associated with the user of the one or more users. The user profile includes the responses to the first set of questions from the user, the calculated composite score for the user, and the generated personality type for the user. Additionally, the method may include matching, by the processor, the user profile with at least one other user profile stored in the database.

In another embodiment, the method may include prompting by the processor, the user of the one or more users to share and compare the stored user profile with a respective user of the matched at least one other user profile.

In another embodiment, the method may further include: generating, by the processor, one or more badges associated with the user profile; and storing, by the processor, the one or more badges associated with the user profile. Each of the one or more badges may be related to: the responses to the first set of questions; the calculated composite score based on the first set of questions; the generated personality type based on the first set of questions; or a combination thereof.

In another embodiment, the selectable module may be based on a theme.

In an embodiment a system for facilitating social activity includes: a graphical user interface (GUI) for visually interacting with a user of one or more users; a data preparer configured to provide, through the GUI, a first set of questions to the user of the one or more users based on a selected module, and receive responses, through the GUI, to the first set of questions from the user of the one or more users. The system further includes a data analyzer configured to calculate a composite score for the user of the one or more users based on the received responses, generate a personality type for the user of the one or more users based on the calculated composite score, and provide, through the GUI, the calculated composite score and the generated personality type to the user of the one or more users. The system further includes a notification generator configured to generate at least one message for prompting content-rich conversations.

In another embodiment, the data analyzer may be further configured to compare the calculated composite score and the generated personality type of the user with a composite score and a personality type of another user of the one more users. The composite score and the personality type of the other user may be calculated and generated based on responses by the other user to the first set of questions. The data analyzer may be further configured: to compare the responses to the first set of questions between the user and the other user; and generate a summary of the comparisons of the respective composite scores, personality types, and responses based on the first set of questions between the user and the other user of the one or more users.

In another embodiment, the system may further include: a transmitter configured to transmit the summary to the user and the other user of the one or more users; and a database configured to store the transmitted summary. The transmitted summary may be associated with the user and the other user of the one or more users.

In another embodiment, the system may further include a communication generator configured to generate a communication session between the user and the other user of the one or more users. The communication session allows for interaction between the user and the other user in real-time.

In another embodiment, the data preparer may be further configured to provide a second set of questions to the user of the one or more users. The second set of questions may be related to the received responses to the first set of questions. The communication session may be prompted by the second set of questions to help the user and the other user of the one or more users to understand the respective scores, personality types, and responses to the first set of questions.

In another embodiment, the system may further include a database configured to store a user profile associated with the user of the one or more users. The user profile includes the responses to the first set of questions from the user, the calculated composite score for the user, and the generated personality type for the user. The data preparer may be further configured to access the user profile stored in the database.

In another embodiment, the system may further include a match generator configured to match the user profile with at least one other user profile stored in the database.

In another embodiment the communication generator may be further configured to prompt, through the GUI, the user of the one or more users to share and compare the stored user profile with a respective user of the matched at least one other user profile.

In another embodiment, the system further includes a badge generator configured to generate one or more badges associated with the user profile and store the one or more badges associated with the user profile. Each of the one or more badges may be related to: the responses to the first set of questions; the calculated composite score based on the first set of questions; the generated personality type based on the first set of questions; or a combination thereof.

In another embodiment, the notification generator may be configured to display through the GUI a first message and a second message to the user and the other user of the one or more users. The first message relates to the responses to the first set of questions, the calculated composite score based on the first set of questions, and the generated personality type. The first message also provides the user of the one or more users information regarding what each composite score and personality type mean. The second message relates to the transmitted summary and highlights similarities in the transmitted summary.

In an embodiment, a system for facilitating social activity includes a means for providing a first set of questions to a user of one or more users. The first set of questions may be based on a selected module. The system further includes: a means for receiving responses to the first set of questions from the user of the one or more users; a means for calculating a composite score for the user of the one or more users based on the received responses; a means for generating a personality type for the user of the one or more users based on the calculated composite score; a means for providing the calculated composite score and the generated personality type to the user of the one or more users; and a means for prompting the one or more users to facilitate insight on the provided calculated composite score and personality type.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described herein with reference to the following drawings.

FIG. 1 depicts a system for facilitating social activity.

FIG. 2 shows an illustrative embodiment of a specialized computer system configured for facilitating social activity.

FIG. 3 shows an illustrative embodiment of a computer-implemented method for facilitating social activity.

FIG. 4 shows another illustrative embodiment of the computer-implemented method for facilitating social activity.

FIG. 5 illustrates a screenshot of a profile from a mobile device in accordance with an embodiment of the disclosed system.

FIG. 6 illustrates a screenshot of a first set of questions on a mobile device in accordance with an embodiment of the disclosed system.

FIG. 7 illustrates a screenshot of a notification screen for a mobile device notifying a user of their calculated score and personality type according to an embodiment of the disclosed system.

FIG. 8 illustrates another screenshot of a notification screen for a mobile device in accordance with an embodiment of the disclosed system.

FIG. 9 illustrates another screenshot of a notification screen for a mobile device notifying users to wait for other additional users to join in accordance with an embodiment of the disclosed system.

FIG. 10 illustrates a screenshot of a summary provided to a plurality of users on a mobile device in accordance with an embodiment of the disclosed system.

FIG. 11 illustrates a screenshot of one or more badges associated with the user profile.

While the disclosed methods and systems are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

As mentioned above, in existing social networking services, a connection is made based solely on shared similarities without exploring differences between users, which results in connections that are not as deep as they could be. These connections between users evolve into fruitless and often confusing and misunderstood communications-leaving the users to wonder why the initial connection failed.

Furthermore, existing social networks leave no room for users to create platonic relations, where the users are allowed to further understand each other and their beliefs.

While many icebreaker activities may be used to create platonic relations, many users lack the direction and guidance needed to effectively create connections and break the ice.

Therefore, there is a need for a social networking service that allows users the ability to communicate and interact more quickly and comfortably in a space that has fun using similarities while at the same time recognizing beauty in differences. There is also a need for a social networking service that allows for developing content-rich conversations and consistently facilitating conversation based on themed questions to recognize both similarities and differences, and help the users understand each other's viewpoints. Thus, there is a need for a platform to recognize connections even when there are “differences” and for a platform to overcome one or more limitations stated above and provide other technical advantages.

The disclosed embodiments relate to a system and method of facilitating social networks. The disclosed embodiments provide greater insight and a deeper understanding of who a user is through a set of questions pertaining to a certain module (i.e., creating a fun social activity). The results from the set of questions may be used to facilitate a connection between users, as opposed to identifying just topical interests in common with another user discovered through user profiles.

More particularly, the disclosed embodiments relate to a system and method to facilitate a connection between users via a structured communication session, such as a facilitating social activity system. The disclosed system/application enables users to connect through a series of questions based on each user's respective answers. In addition, the disclosed system/application can further facilitate the communication session between users by helping the users understand their similarities and differences. The disclosed system/application may involve individual software components or functional segments. These software applications or systems may be newly developed and/or updated from time to time.

As used herein, social activity may refer to activities that involve communication and interaction with others. Such social activities are built into social systems such as work, school, culture, and the like. For example, a meeting, class, game, party, dance, and the like may be considered social activities.

According to an embodiment, the disclosed system/application provides a first set (e.g., series) of questions to a user of one or more users based on a selected module (e.g., theme), and receives the responses to the first set of questions from the user. The first set of questions is created to break the ice and create a fun and safe environment for the user. The responses to the first set of questions generate a composite score and personality type of the user to help the user determine with which of the identified personalities or types they match.

For example, the series of questions may pertain to different subjects, such as TV shows, movies, politics, astrology/zodiac signs, etc., based on the selected module. The selected module may pertain to any topic such as politics, anatomy, pop culture, and the like. The user may or may not have any prior knowledge of any of these subjects but based on their answers to the series of questions, the user is provided with a result (e.g., “your zodiac sign is Aries,” “the character of the TV show Riverdale that you relate most to is Archie Andrews,” “your political affiliation is mostly democratic,” and the like). The result may or may not align with what the user may have previously considered themselves to be, which can be a fun and new learning experience in and of itself. Furthermore, a summary may provide the user further insight into why and how the user received such a result, thus providing a deeper level of understanding.

According to an embodiment, the disclosed system/application may further match or connect users based on the results from the series of questions provided. The disclosed system/application may match users with similar results and create a connection session between the matched users. For example, the matched users may connect with other users who obtain the same results (e.g., answers from the set of questions, scores, personality types, and the like). Furthermore, as more users join or participate, the system dynamically matches users with new users. Thus, users with similar personality types based on a module may be matched together to initiate a conversation through a communication session. As will be discussed below, the users may or may not perform the module (i.e., answer the questions) at the same time, yet are still able to find and match with other users having similar personality types and scores.

According to another embodiment, the disclosed system/application may further enable the users to compare their answers to each of the questions answered to see how similar or different the users are. Conventional social applications provide no avenue for users to compare similarities and differences. However, providing an avenue to compare and see others' responses can further facilitate communication, facilitate insight, and create a deeper connection between users.

For example, a series of questions may contain any number of questions (5, 10, 20, etc.). While Users X and Y may have the same composite score or result, their respective answers may not be identical. In this way, hundreds or thousands of users may share the same result, but their answers to the series of questions may vary. Being able to see how similar your answers are with other users' answers is beneficial since users who answered the exact same questions in the exact same way may be more aligned with each other, meaning they may share similar viewpoints, likes/dislikes, and the like, which allows them to connect with one another more easily and/or on a deeper level.

According to another embodiment, the disclosed system/application may further enable the users to gain insight on one another. Insight on each user is provided to help the users gain a deeper level of understanding for each other no matter what outcome is derived. In other words, the first set of questions dynamically helps determine a user's personality type based on how each user answers each question. A summary is provided explaining what question or questions weighted favorably in deciding a personality type for that user, and why that user's answer to that question did not fit with other possible personality types. In this regard, the disclosed system/application is said to have facilitated insight by giving the users context to their answers and derived outcomes.

According to an embodiment, the disclosed system/application may further enable users with similar and different backgrounds and/or viewpoints to create a connection. The disclosed system/application enables two or more users to answer a series of questions during a social activity and compare results in real or non-real-time. As mentioned above, the set of questions is designed to break the ice between users and help facilitate the social activity. A second series of questions may be provided to further facilitate the conversation and enable users to further understand their similarities and differences in a fun and safe environment.

For example, Users X and Y have never met and want to get to know one another. The disclosed system/application can create a communication session between the users and provide both users a first set of questions to answer and compare in real-time. The first set of questions may correspond to a module. Users X and Y may have a limited amount of time to answer the first set of questions. Once completed, results are provided to each user, and each user can see the others' results to compare. The disclosed system/application may then: prompt the users to compare with a second set of questions; compare the results of the second set of questions; and/or facilitate the conversation with the second set of questions. The second set of questions helps the users get to the root of their similarities/differences and viewpoints. Thus, facilitating conversations by allowing users an avenue to understand other views and still connect even if the connected users are different, enables users to embrace diversity and differences.

According to an embodiment, the disclosed system/application may further match or connect users based on stored badges of completed modules. The modules may contain a predetermined number of themed questions. The disclosed system/application may save responses, composite scores, and personality types for each chosen theme for a user and store them as badges under the user profile. Thus, creating a history of the user's progress further facilitates another deeper level of understanding of who the user is and shows how and why the user received each score and personality type for each module the user completed. Each of the stored badges may be compared with other users' badges to determine and create strong connections (e.g., a connection with frequent similarities).

For example, User X has completed a first set of questions on its own based on a chosen module. User X receives its results which may or may not align with what User X may have previously thought of themselves or considered themselves to be, which can be a fun and new learning experience in and of itself. After completion of every module, User X receives a badge stored under its user profile. The results corresponding to each of the completed modules by User X are stored under each corresponding badge. The disclosed system/application may now compare User X's badges with other users to determine potential connections based on the results provided from each completed module and provide User X with further information when compared against a larger community (e.g., statistics of the personality type of the user and the like).

According to an embodiment, the disclosed system/application may further match or connect users based on stored badges of completed modules at the discretion of the user. The disclosed system/application may save responses, composite scores, and personality types for each chosen module for a user and store them as badges under the user profile. The user may then share its badges with other known or unknown users to create a connection based on similarities or differences. In other words, even if one or more users did not perform the module simultaneously, the resulting badges can be used to facilitate conversation and connection with the understanding that one may have a composite of previous badges from previous modules that are stored in one's profile. Thus, the user can meet others at their own discretion and for their own reasons.

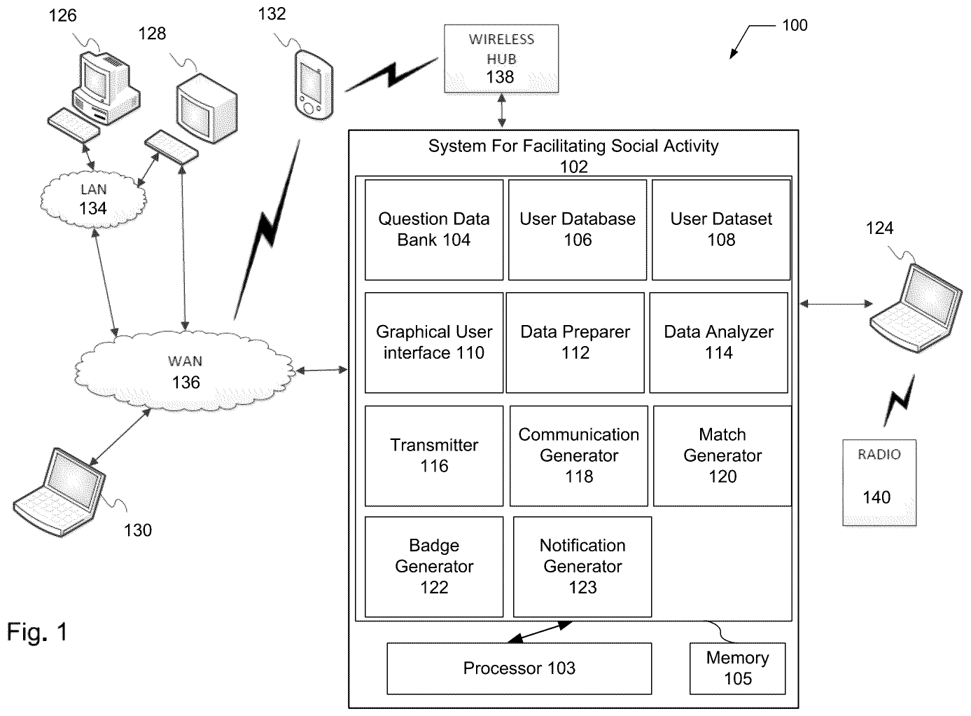

Referencing FIG. 1, a network environment 100 for developing content-rich conversations and consistently facilitating conversation based on themed questions to recognize both similarities and differences, is depicted. A system for facilitating social activity 102 is further illustrated in FIG. 1 and may receive, transmit, and/or store electronic documents and summaries in a user dataset 108 between users, such as via wide area network 136 and/or local area network 134 and computer devices 124, 126, 128, 130 and 132, as will be described below, coupled with the system 102.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

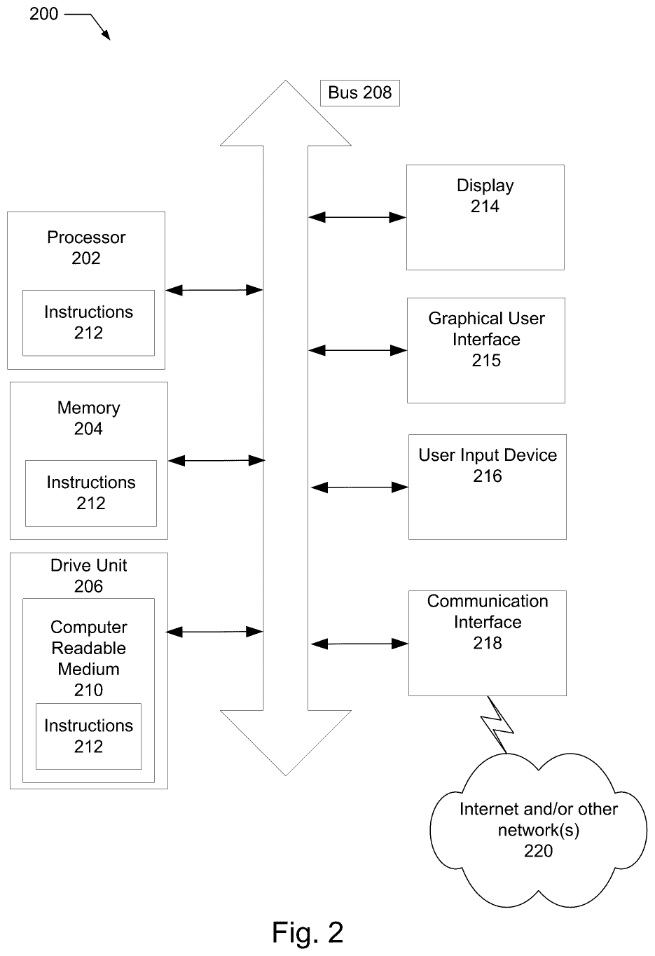

The system 102 shown in FIG. 1 may be implemented as a separate component or as one or more logic components, such as on a field programmable gate array (FPGA) that may include a memory 105 or reconfigurable component to store logic and a processing component to execute the stored logic, or as computer program logic, stored in the memory 105, or other non-transitory computer readable medium, and executable by a processor 103, such as the processor 202 and memory 204 described below with respect to FIG. 2. In one embodiment, the system 102 is implemented by a server computer, e.g., a web server, coupled with one or more client devices 124, 126, 128, 130, and 132, such as computers, mobile devices, etc. via a wired and/or wireless electronic communications network, such as the wide area network 136, local area network 134, and/or radio 140, in a network environment 100. In one embodiment, client devices 124, 126, 128, 130, 132 interact with the system 102 of the server computer to provide inputs thereto and receive outputs therefrom as described herein. The system 102 may also be implemented with one or more mainframe, desktop or other computers, such as the computer 200 described below with respect to FIG. 2.

As illustrated in FIG. 1, the system 102 is incorporated as one system with different modules within the system. In another embodiment, the system 102 may be separate and distinct with multiple separate modules. It will be appreciated that the disclosed embodiments may be applicable to other types of electronic documents and messages, and systems, beyond those described specifically with respect to the system 102. Further, the question data bank 104, the user database 106, the user dataset 108, or other datasets, and/or the data contained therein, may be communicated throughout the system using one or more data packets, datagrams or other collection of data formatted, arranged configured and/or packaged in a particular one or more protocols, e.g. FTP, UDP, TCP/IP, Ethernet, etc., suitable for transmission via networks 134 and 136 as was described, such as the dataset communication format and/or protocols.

The system 102 includes a processor 103 and a non-transitory memory 105 coupled therewith which may be implemented as processor 202 and memory 204 as described below with respect to FIG. 2. As shown, the system 102 includes various logical functions, individual devices, and/or combined devices. The logical functions, individual devices, and/or combined devices may share the processor 103 as shown, or may include individual processors, as well as any combination or shared processing abilities over multiple processors. As such, multiple processors 103 may be used in dedicated applications for the particular individual devices, and/or combined devices, or in any shared combination.

The system 102 includes: a question data bank 104; a user database 106; a user dataset 108; a graphical user interface (GUI) 110, a data preparer 112; a data analyzer 114; a transmitter 116; a communication generator 118; a match generator 120; a badge generator 122; and a notification generator 123. The question data bank 104, the user database 106, the user dataset 108, the GUI 110, the data preparer 112; the data analyzer 114; the transmitter 116; the communication generator 118; the match generator 120; the badge generator 122, and the notification generator 123 are stored in the memory 105.

The electronic documents of the user dataset 108, received, transmitted, and/or stored by the system 102, may be a plurality of electronic documents and may include, for example, information relating to users and other users of the system 102, such as, usernames, passwords, notes, scores, personality types, badges, summaries, and the like. The electronic documents of the user dataset 108 contain at least some information derived from a question data bank 104 and a user database 106 of the system 102, or contain verbatim mentions of data from both the question data bank 104 and the user database 106.

The question data bank 104 or data structure may include sets of questions and answers, where each of the sets of questions and answers is based on a module (i.e., theme, topic, or the like). For example, each module may be based on a certain theme such as, zodiac signs, movies, books, politics, and the like. Each module may have at least one set of questions based on the theme of the module. There may be a predetermined number of questions for each set of questions such as 10 questions, however the number of questions in each set are not limited to 10 but may be any number of questions. The number of sets of questions are not limited either.

The user database 106 may include data identifying or relating to a user or users, such as names, ages, genders, usernames, passwords, and all other personal identification information.

The user dataset 108 may contain a large collection of electronic documents, for example, information relating to users and other users of the system 102, such as, composite scores, personality types, badges, summaries, and the like. A transmitter 116 (described below) is configured to transmit the summary to the user dataset 108 (i.e., a database) to be stored therein. For instance, a summary may include a first set of questions and respective answers for the first set of questions retrieved from the question data bank 104. A summary may further include of a comparison of respective composite scores, personality types, and responses between one or more users or a general population of users.

In one embodiment, the documents of the user dataset 108 may be structured with a pre-defined data model or format. In another embodiment, the documents of the user dataset 108 may be unstructured. In yet another embodiment, the user dataset 108 may contain both structured and unstructured documents. Structured data is data in a defined format, or code, that makes it easily readable and/or searchable by a computer. Examples of structured data include JavaScript Object Notation (JSON), Extensible Markup Language (XML) formatted files, YAML Ain′t Markup Language (YAML) and fixed width/field file formats. Unstructured data is not structured with pre-defined data models or schema. Examples of unstructured data may include the content of documents, journals, books, health records, metadata, audio, video, analog data, images, files, and unstructured text such as the body of an e-mail message, Web page, or word-processor document. Besides the difference between how structured or unstructured data is stored in a relational database versus stored outside of one, the biggest difference is the ease of analyzing structured data versus unstructured data. Mature analytics tools exist for structured data, but analytics tools for mining unstructured data may be emerging and developing. Dealing with unstructured data is important, since a vast majority (i.e., 80% or higher) of all potentially usable business information may originate in unstructured form.

It will be appreciated that the question data bank 104, the user database 106, and the user dataset 108 may be stored in a memory 105 or other non-transitory medium coupled with the system 102 and may be implemented by a plurality of databases, each of which stores a portion of the information. The question data bank 104, the user database 106, and the user dataset 108 are structured with a pre-defined data model or format, such as a relational database having a relational model of data. The question data bank 104, the user database 106, and the user dataset 108 include a plurality of data items, or entities, stored in association with one or more properties. Each property is associated with a value. The relation from an item to a property is a one to many, with each of the latter having an associated value. In a Relational Database Management System (RDBMS), which is a software system used to maintain relational databases, an item is a row and a property is a related value of the item in a column. Stated another way, a property is an entity's data value, or the data instances themselves. A name space may be incorporated into the name of a property since there is no hierarchy to them. For example, the property “user.age” could represent a column “age” in a “user” table found in an RDBMS.

Further, as mentioned above, the GUI 110 instructions are stored in the memory 105 and executable by the processor 103. The GUI 110 may be used for one or more purposes, including to convey information about the users, displaying (e.g., outputting) scores, personality types, a set of questions, results from the set of questions, badges, prompts to facilitate conversation between users, summaries, and the like. The GUI 110 may also be used to input answers to a first and second set of questions and respective answers for the first and second set of questions retrieved from the question data bank 104, convey messages between users, and the like.

For example, the system 102 may provide a user of one or more users a set of questions based on a selectable module (e.g., theme, topic, or the like) by the user of the one or more users. The system 102 allows the user to input into the GUI 110 a module. A first set of questions based on the selected module are provided to the user. The GUI 110 may display the set of questions based on the selected module to the user, and the users may input, into the GUI 110, responses to each respective question of the set of questions. The GUI 110 may display a calculated composite score and a generated personality type to the user. The GUI 110 may also display a summary being associated with the user and the other user of the one or more users. In other words, the summary may be a comparison of the respective composite scores, personality types, and responses for each respective user based on a first set of questions. Further, the summary may help facilitate insight on the provided calculated composite score and personality type. The summary may facilitate insight by providing an analysis of how and why each user received their respective composite score and personality type for a particular module. The analysis is based on how each question from the set of questions was answered by each respective user. By providing an analysis that explains what question(s) weighed favorably in deciding the composite score and/or personality type for that user, and why that user's answer to that question did not fit with other possible composite scores and/or personality types, insight is provided to the users.

Furthermore, the GUI 110 may display multiple prompts, instructing the user of the one or more users to input information, perform acts, and the like. For example, the GUI 110 may prompt the user to finish answering the first set of questions with a predetermined time limit or invite other users to complete the same set of questions. The GUI 110 may also prompt the user to initiate interactions with another user, such as establishing a communication session, described below.

In another example, the GUI 110 may be a communication interface to allow users to message each other through a communication session. The communication session can be a communication session such as a telephone call between two users or a communication session between three or more users. The communication session can be mode-neutral so that users in the session can communicate using any of a number of communication modes such as telephone, cellular phone, voice over IP (VOIP), video conference, text message, instant messaging, web-based chat, e-mail, live in-person conversation, and so forth. The communication session can also be multi-media/modal and combine two or more of the modes listed above. The GUI 110 allows users to manipulate the communication session quickly and intuitively.

In another example, the GUI 110 may include icons for each user profile, badges, and the like. For example, a user may click on an icon of another user to engage with the selected user's profile. Once in the user's profile, badges can be seen, illustrating completed modules. Further, the selected profile may display information the user decided to make public. Such information may include: birth date, age, location, scores, personality types, and the like.

As mentioned above, the system 102 may include a data preparer 112 that may access data from both the question data bank 104 and the user database 106, and generate a document to be stored in the user dataset 108, such as an electronic document including composite scores, personality types, badges, and the like.

It will be appreciated that documents generated or derived from both the question data bank 104 and the user database 106 may be generated by sources other than the data preparer 112. For example, the data preparer 112 of the system 102 may receive a document containing data derived from the question data bank 104 and the user database 106 from another authorized computer system, such as computer devices 124, 126, 128, 130, and 132, via wide area network 136 and/or local area network 134, and transfer the received document into the user dataset 108. In another embodiment, the document received from another authorized computer system, such as computer devices 124, 126, 128, 130, and 132, via wide area network 136 and/or local area network 134, may be transferred directly into the user dataset 108 without being processed by the data preparer 112.

The data preparer 112 provides a set of questions, such as a first set of questions, retrieved from the question data bank 104, to a user of one or more users based on a selected module by the user. The data preparer 112 may also receive responses to the first set of questions from the user. The data preparer 112 may store the selected questions, based on the selected module, by the one or more users with the corresponding responses to the selected questions under each respective user of the one or more users in the user dataset 108. This may be done for each set of questions provided, which is not limited to just a first set and second set. Each of the stored questions and responses are stored under each respective user profile. In other words, User X wishes to complete a module pertaining to Harry Potter. User X receives a first set of questions based on the selected module and inputs the answers to the first set of questions through the GUI 110. The user may input the answers to the first set of questions within a time limit such that the first set of questions are answered in real-time. The responses to the first set of questions may be stored under User X's profile in the user dataset 108. User X may receive a Harry Potter badge, under its profile, to signify that User X completed the “Harry Potter” module. The Harry Potter badge may contain the composite score and/or the personality type the user received for the completed module. Furthermore, the Harry Potter badge may contain the summary provided to the user so that the user may see his/her analysis of the completed module.

Furthermore, the data preparer 112 may be configured to provide a second set of questions to the user of the one or more users through the GUI 110. The second set of questions are related to the received responses to the first set of questions. Additional sets of questions may be provided as well, and subsequent sets of questions may or may not be related to either the previous sets of questions or the answers to those sets of questions.

A communication session, by a communication generator 118, may be initiated to help the user and the other user of the one or more users understand their respective composite scores, personality types, and responses to the first set of questions. In one example, the communication session may be performed simultaneously. In other words, the communication may be conducted in real-time to keep users on pace within a time limit. The communication session may be conducted between users who are both present and can communicate face-to-face, or the communication may be conducted via a wired and/or wireless electronic communications network. In other words, if multiple users are participating in a selected module, the users may communicate to each other in person or may communicate via a wired and/or wireless electronic communications network, i.e., messaging, e-mail, text, phone-call, or the like.

The data preparer 112 may be also configured to access the user database 106. As mentioned above, the user database 106 includes a user profile associated with the user of the one or more users. The user profile includes responses to any number of sets of questions from the user, corresponding calculated composite scores for the user, and corresponding generated personality types for the user.

A data analyzer 114 is provided and configured to calculate a composite score for the user of the one or more users based on the received responses for the first set of questions based on the selected module. The composite score may be a score of the number of answered questions from the first set of questions and/or a descriptive comment. The descriptive comment may be the summary provided, the composite score, an analysis explaining the composite score and personality type, or a combination thereof.

The data analyzer 114 is further configured to generate a personality type for the user of the one or more users based on the calculated composite score, and provide the calculated composite score and the generated personality type to the user.

For example, User X selects a Harry Potter module with a first set of questions based on the movies/books of Harry Potter. The data preparer 112 provides the selected questions to the user and the user answers the first set of questions. The data analyzer 114 calculates a composite score and personality type based on the responses to the first set of questions. In one example, User X may receive an 8/10 for their composite score and receive a personality type as “House Slytherin.”

Furthermore, the generated personality type may be derived from a dynamically changing summation of received responses. For instance, Users X, Y, and Z decide to complete a module to determine what kind of leadership traits they possess. In this example, there are four possible leadership traits that Users X, Y and Z, can be. The four traits are “Weight Carrier,” “Deflector,” “Shrugger,” and “Anarchist.” Each question directs Users X, Y, and Z to one of the leadership traits listed above based on how the users respond to each respective question. For example, if User X answers question 1 as “Directly Handle” and Question 2 as “Seek Resolution,” the data preparer 112 may provide User X with a generated personality type of “Weight Carrier.” The generated personality type may be derived from the example equation below:
Question 1: “Directly handle”+Question 2: “Seek Resolution”+ . . . (Question #N)=“Weight Carrier”
   The equation above adds all of the responses from each respective question to a predetermined personality type. The generated personality type dynamically changes as each question is answered. However, if User X answers the questions differently, a different personality trait may be generated. An example of how the different personality traits may be generated differently based on how a combination of questions are answered is shown below:
Question 1: “Directly handle”+Question 2: “Seek Resolution”=“Weight Carrier”
Question 1: “Directly handle”+Question 2: “Indifferent on Resolution”=“Anarchist”
Question 1: “Indirectly handle”+Question 2: “Seek Resolution”=“Deflector”
Question 1: “Indirectly handle”+Question 2: “Indifferent on Resolution”=“Shrugger”
   Therefore, based on how User X answers each question from the selected module, a different personality type may be generated. As mentioned above, the equation is not limited to two questions/inputs but may be any number of questions.

The data analyzer 114 is further configured to compare the calculated composite score and the generated personality type of the user with a composite score and a personality type of another user of the one more users. The composite score and the personality type of the other user are calculated and generated based on responses by the other user to the first set of questions.

Furthermore, the data analyzer 114 is configured to compare the responses to the first set of questions between the user and the other user, and generate a summary. The summary may contain detailed comparisons of the respective composite scores, personality types, and responses based on the first set of questions between the user and the other user. The summary may facilitate insight by providing an analysis of how and why each user received their respective scores. The analysis is based on how each question from the set of questions was answered by each respective user. By providing an analysis that explains what question(s) weighed favorably in deciding a personality type for that user, and why that user's answer to that question did not fit with other possible personality types, insight is provided to the users. The comparing of responses and generating a summary may be done for any number of sets of questions.

In one example, Users X, Y, and Z all decide to try a module based on zodiac signs. A first set of questions is presented to Users X, Y, and Z based on the selected module. The selected module has 12 Zodiac signs to sort the users into. The data analyzer 114 compares User X's, Y's, and Z's composite scores and personality types. Furthermore, the data analyzer 114 compares User X's responses with User Y's and User Z's responses and generates a summary of the comparison of the respective composite scores, personality types, and responses. The summary provides an analysis explaining what question(s) weighed favorably in deciding a personality type for that user, and why that user's answer to that question did not fit with other possible personality types. For example, Users X and Y both answered Question 4 that they prefer to take on issues directly. This scored heavily into their final score and indicated that both Users X and Y are “Aries.” User Z answered Question 4 that it prefers to hand problems over to someone else. Thus, User Z's answer eliminated the possibility of User Z being scored as “Aries.” However, all three Users X, Y, and Z answered the following Question 5 that “they prefer to see a problem reach a resolution and prefer to follow up.” This is important because if Users X and Y would have answered Question 5 that they “don't really care how a problem is resolved” then that answer would have scored them as “Virgos.” Even though Users X, Y, and Z scored differently in the end, all have a shared trait of wanting to see problems through to the end and wanting resolution. Accordingly, a deeper understanding of the users is provided through the generated summary to further facilitate insight and find similarities. This added level of feedback provides much more than simply a calculated score or determining a user “matches” with another user.

In another example, the calculated composite score and the generated personality type of the user may also be compared with a general population of users who completed the same first set of questions. The data analyzer 114 compares User X's calculated composite score, personality type, and responses to a larger community of users who completed the same first set of questions based on the same selected module. For example, User X may be able to see what percentage of other users who have completed the same module also received the same badge. In other words, User X may be able to determine where User X fits in the world of “module takers.”

As mentioned above, a transmitter 116 is provided in the system 102 and is configured to transmit the summary generated by the data analyzer 114 to the user and the other user of the one or more users. The transmitter 116 is further configured to transmit the summary to the user dataset 108 (i.e., a database) to be stored therein. Each generated summary is associated with each respective user of the one or more users for each respective module. For example, Users X and Y receive a respective summary pertaining to a selected module, the module being selected by either User X or Y. The summary contains a comparison of the respective composite scores, personality types, and responses between Users X and Y. The summary may be transmitted to User X and User Y upon the completion of the selected module. The summary may be stored in the user dataset 108 as a history of completed summaries for User X and may be stored in the user dataset 108 as a history of completed summaries for User Y. Each user's history may be used to help develop a user profile for future connections. The summary may also be stored under a respective badge for that completed module for each user.

Furthermore, the system 102 includes a communication generator 118. The communication generator 118 is configured to generate a communication session between the user and the other user of the one or more users. The communication session allows for interaction between the users. The communication session may be performed in real-time.

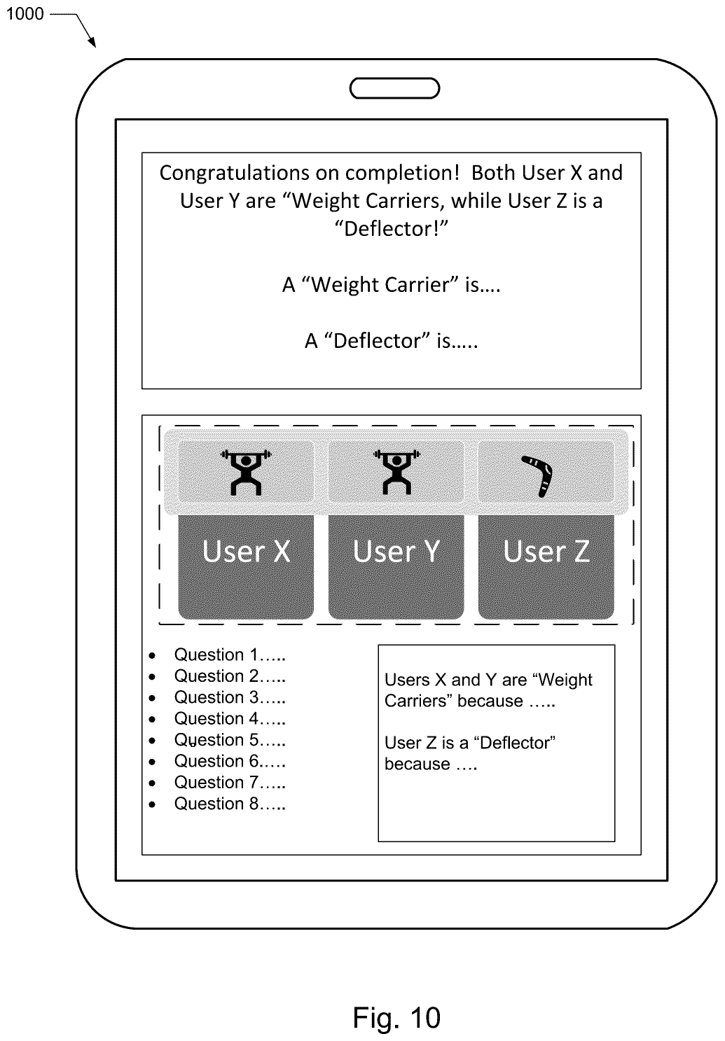

For example, User X invites User Y to complete a first set of questions based on a selected module. Both User X and User Y receive their respective calculated composite scores, personality types, and summaries. The summaries are based on the comparison of the respective scores, personality types, and responses between User X and User Y. The transmitter 116 transmits User X's and User Y's respective summaries to each other. The communication generator 118 may generate a communication session to have both User X and User Y interact with each other, once prompted through the GUI 110, to facilitate insight on the provided calculated scores and personality types. In other words, based on how Users X and Y answer each question of the first set of questions may help determine who each user is by dynamically sorting each user into its respective personality types. Users X and Y might end up having different personality types based on how each user answered each question. However, similarities between the users still exist, and a common ground may be found and provided in an explanation to each user to help them understand each other on a deeper level, as will be further described below with reference to FIG. 10.

Furthermore, as mentioned above, the system 102 includes a match generator 120. The match generator 120 is configured to match the user profile with at least one other user profile stored in the database. The match generator 120 may match one user to a number of different users. As more users join the application, the match generator 120 may dynamically continue to match users together. Furthermore, the match generator 120 may continue to update and match users as the users continue to grow (e.g. evolve) their profiles and complete more modules. For example, User X completes a module on Harry Potter. User Y completes the same module on Harry Potter. Both User X and User Y have similar composite scores and personality types. User X is matched with User Y based on their composite scores and personality types. In other words, matching two users based on their similar composite scores and personality types provides a greater chance for a connection to occur. Furthermore, when a connection does occur, User X and User Y may start a communication session or may both start a new activity together based on a new set of first questions (or further sets of questions related to the first set of questions both users already answered). The new set of questions may be any new module that both User X and User Y have agreed to work on.

The badge generator 122, as mentioned above, is configured to generate one or more badges associated with the user profile. Each of the one or more badges is related to: the responses to the first set of questions; the calculated score based on the first set of questions; the generated personality type based on the first set of questions; or a combination thereof. The user dataset 108 is configured to store the generated one or more badges associated with the user profile.

The notification generator 123, as mentioned above, is configured to display at least one message to the user and the other user of the one or more users to further facilitate insight on the provided calculated composite score and personality type. A first message of the at least one message relates to the responses to the first set of questions, the calculated composite score based on the first set of questions, and the generated personality type. For example, the first message may provide the user information regarding what each score and personality type mean. A second message may relate to the transmitted summary and may highlight similarities in the transmitted summary.

Additionally, the notification generator 123 may notify users of the amount of time or the user's pace in completing a first set of questions in a selected module. In one example, users are encouraged to complete each first set of questions in real-time to encourage connections to occur simultaneously.

The network environment 100 shown in FIG. 1 includes computer devices 124, 126, 128, 130, and 132, which depict different methods or media by which a computer device may be coupled with the system 102 or by which a user may process or communicate, e.g., send and receive, electronic documents or other information therewith. It will be appreciated that the types of computer devices deployed by users and the methods and media by which they communicate with the system 102 is implementation dependent and may vary and that not all of the depicted computer devices and/or means/media of communication may be used and that other computer devices and/or means/media of communications, now available or later developed may be used. Each computer device, which may comprise a computer 200 described in more detail below with respect to FIG. 2, may include a central processor that controls the overall operation of the computer and a system bus that connects the central processor to one or more conventional components, such as a network card or modem. Each computer device may also include a variety of interface units and drives for reading and writing data or files and communicating with other computer devices and with the system 102. Depending on the type of computer device, a user can interact with the computer with a keyboard, pointing device, microphone, pen device, touch screen, or other input device now available or later developed.

An exemplary computer device 124 is shown directly connected to the system 102 in FIG. 1, such as via a T1 line, a common local area network (LAN) or other wired and/or wireless medium for connecting computer devices, such as the network 220 shown in FIG. 2 and described below with respect thereto. The exemplary computer device 124 is further shown connected to a radio 140. The user of radio 140, which may include a cellular telephone, smartphone, or other wireless proprietary and/or non-proprietary device, may be a user of the application. The radio user may transmit electronic documents or other information to the exemplary computer device 124 or a user thereof. The user of the exemplary computer device 124, or the exemplary computer device 124 alone and/or autonomously, may then transmit the electronic documents or other information to the system 102.

As shown in FIG. 1, exemplary computer devices 126 and 128 are coupled with a local area network (“LAN”) 134 which may be configured in one or more of the well-known LAN topologies, e.g., star, daisy chain, etc., and may use a variety of different protocols, such as Ethernet, TCP/IP, etc. The exemplary computer devices 126 and 128 may communicate with each other and with other computer and other devices which are coupled with the LAN 134. Computer and other devices may be coupled with the LAN 134 via twisted pair wires, coaxial cable, fiber optics or other wired or wireless media. As shown in FIG. 1, an exemplary wireless personal digital assistant device (“PDA”) 132, such as a mobile telephone, tablet-based compute device, or other wireless device, may communicate with the LAN 134 and/or the Internet 136 via radio waves, such as via Wi-Fi, Bluetooth and/or a cellular telephone based data communications protocol. PDA 132 may also communicate with the system 102 via a conventional wireless hub 138.

FIG. 1 also shows the LAN 134 coupled with a wide area network (“WAN”) 136, which may be comprised of one or more public or private wired or wireless networks. In one embodiment, the WAN 136 includes the Internet 136. The LAN 134 may include a router to connect LAN 134 to the Internet 136. Exemplary computer device 130 is shown coupled directly to the Internet 136, such as via a modem, DSL line, satellite dish or any other device for connecting a computer device to the Internet 136 via a service provider therefore as is known. LAN 134 and/or WAN 136 may be the same as the network 220 shown in FIG. 2 and described below with respect thereto. One skilled in the art will appreciate that numerous additional computers and systems may be coupled to the system 102.

The operations of computer devices and systems shown in FIG. 1 may be controlled by computer-executable instructions stored on a non-transitory computer-readable medium. For example, the exemplary computer device 126 may include computer-executable instructions for receiving electronic documents from a user and transmitting that information to the system 102. In another example, the exemplary computer device 128 may include computer-executable instructions for providing electronic messages to the system 102 and/or receiving electronic documents or other messages from the system 102 and displaying that information to a user.

Of course, numerous additional servers, computers, handheld devices, personal digital assistants, telephones and other devices may also be connected to the system 102. Moreover, one having ordinary skill in the art will appreciate that the topology shown in FIG. 1 is merely an example and that the components shown in FIG. 1 may include other components not shown and be connected by numerous alternative topologies.

As illustrated in FIG. 1, the system 102 is incorporated as one system with different modules within the system. In another embodiment, the system 102 may be separate and distinct with multiple separate modules. It will be appreciated that the disclosed embodiments may be applicable to other types of electronic documents and messages, and systems, beyond those described specifically with respect to the system 102. Further, the question data bank 104, the user database 106, and the user dataset 108, or other datasets, and/or the data contained therein, may be communicated throughout the system using one or more data packets, datagrams or other collection of data formatted, arranged configured and/or packaged in a particular one or more protocols, e.g. FTP, UDP, TCP/IP, Ethernet, etc., suitable for transmission via networks 134 and 136 as was described, such as the dataset communication format and/or protocols.

Referring to FIG. 2, an illustrative embodiment of a general computer system 200 is shown. The computer system 200 can include a set of instructions that can be executed to cause the computer system 200 to perform any one or more of the methods or computer based functions disclosed herein. The computer system 200 may operate as a standalone device or may be connected, e.g., using a network, to other computer systems or peripheral devices. Any of the components discussed above, such as the processor 103, may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that can communicate via a bus 208. The memory 204 may be a main memory, a static memory, or a dynamic memory. The memory 204 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random-access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions 212 stored therein or stored in the memory 204. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

As shown, the computer system 200 may further include a display unit 214, such as a liquid crystal display (LCD), an organic light emitting diode (OLED), a flat panel display, a solid-state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in the drive unit 206.

Furthermore, the computer system 200 may include a graphical user interface (GUI) 215 configured to allow users to interact with electronic devices through graphical icons and audio indicators. The GUI 215 may act as an interface for the user to see the functioning of the processor 202, or specifically as an interface with the software stored in the memory 204 or in the drive unit 206.

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control, or any other device operative to interact with the system 200.

In a particular embodiment, as depicted in FIG. 2, the computer system 200 may also include a disk or optical drive unit 206. The disk drive unit 206 may include a computer-readable medium 210 in which one or more sets of instructions 212, e.g., software, can be embedded. Further, the instructions 212 may embody one or more of the methods or logic as described herein. In a particular embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 can communicate voice, video, audio, images or any other data over the network 220. Further, the instructions 212 may be transmitted or received over the network 220 via a communication interface 218. The communication interface 218 may be a part of the processor 202 or may be a separate component. The communication interface 218 may be created in software or may be a physical connection in hardware. The communication interface 218 is configured to connect with a network 220, external media, the display 214, or any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to, TCP/IP based networking protocols.

Embodiments of the subject matter and the functional operations described in this specification may be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. A system may depend on certain rules, logic, and inter-related objects and data. In technical and computing environments, a system may calculate values for multiple objects subject to rules, e.g., business or environment logic, associated with the objects. Certain object types may also depend on other object types.

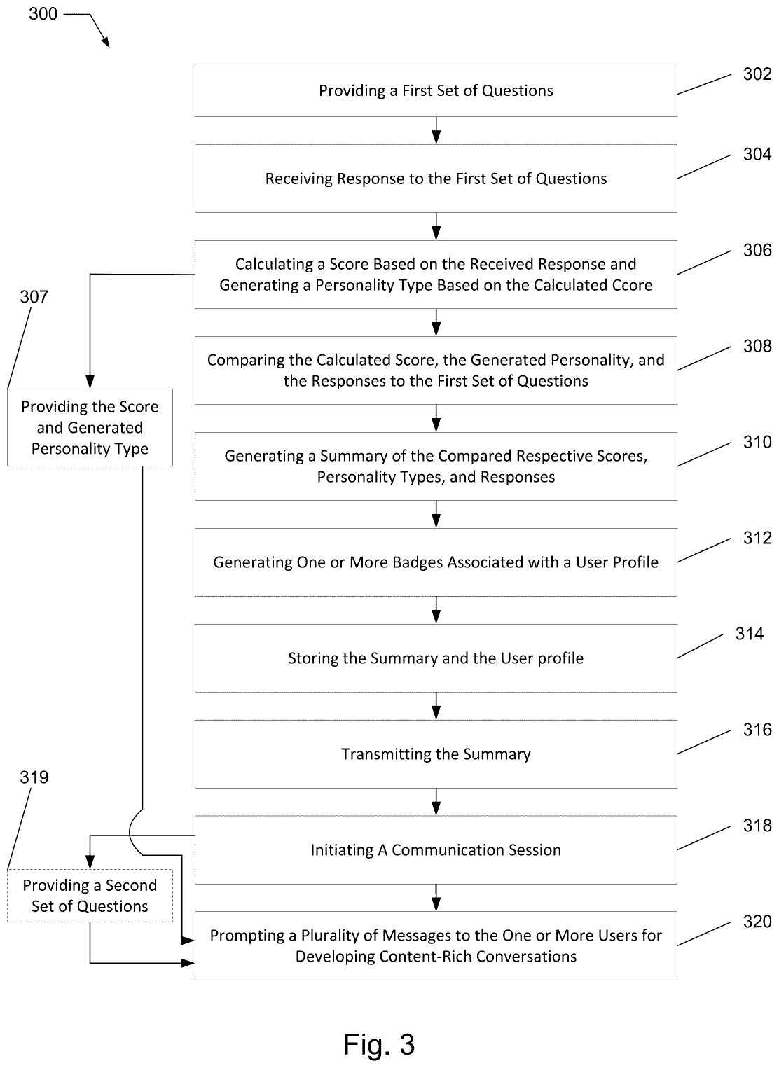

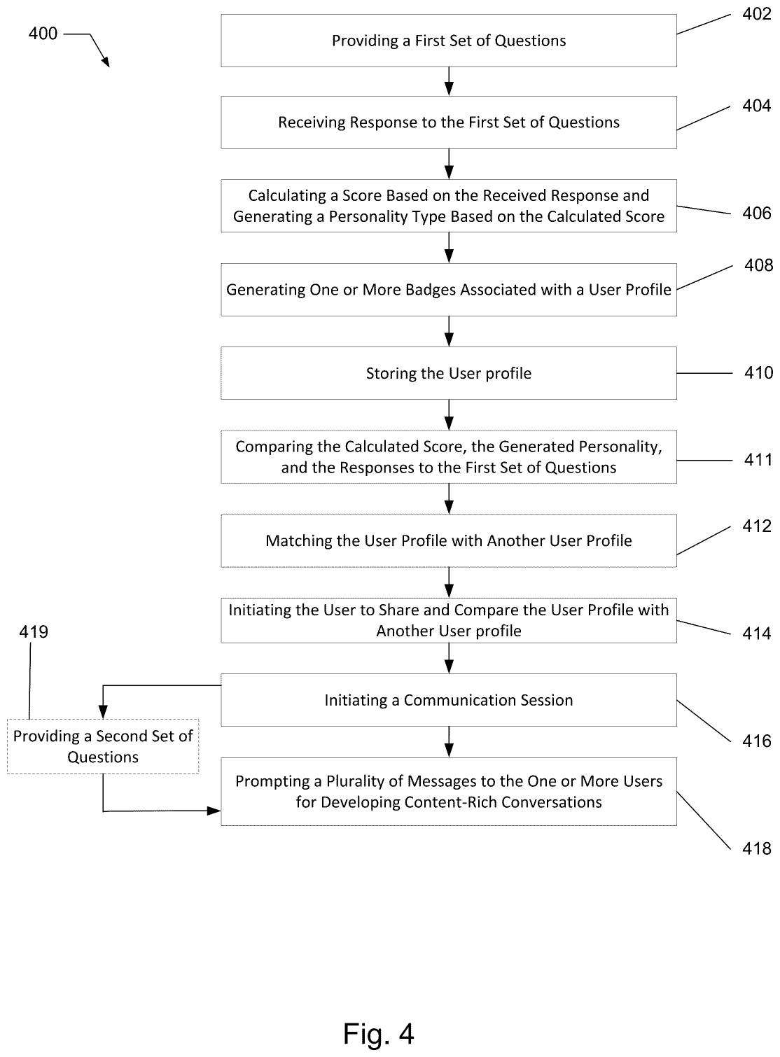

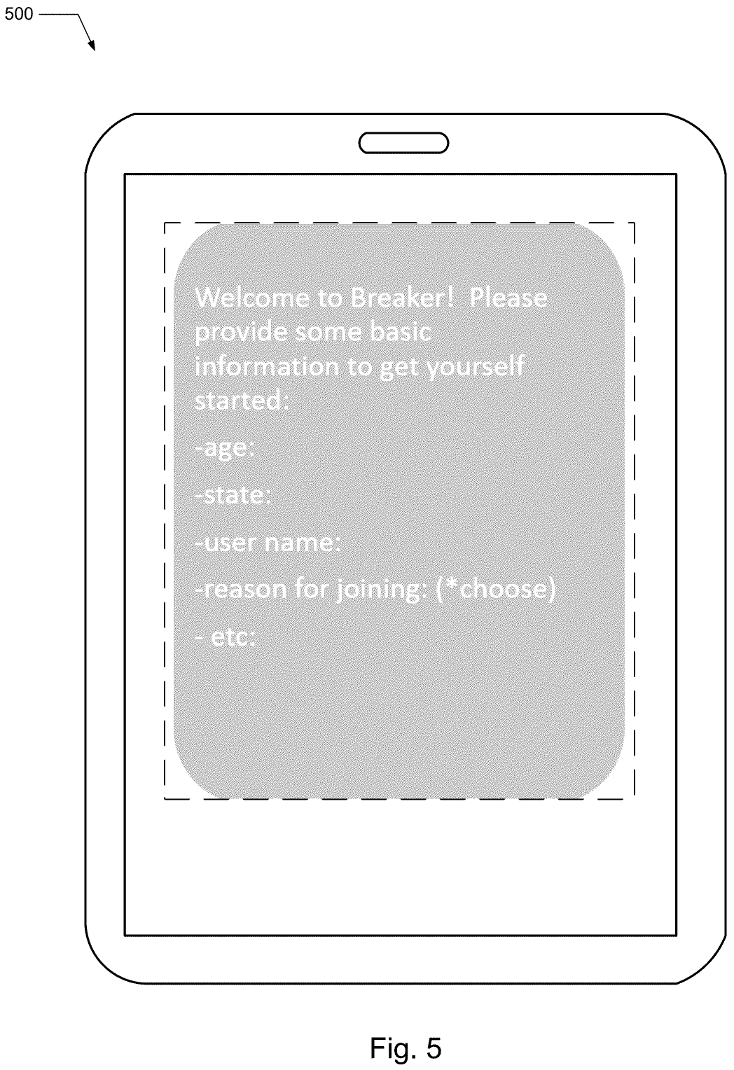

Described below with reference to FIGS. 3-11 is an example of an operation of an application of one embodiment of the present disclosure for a mobile device or computer. For example, when a user opens the application for the first time, the user is prompted to create a user profile. FIG. 5 illustrates a screenshot of a profile screen 500 from a mobile device in accordance with an embodiment of the disclosed system. The profile screen 500 includes information that may be made public or private. As illustrated in FIG. 5, the user may need to provide some basic information about him/herself. Such information may be age, gender, what state the user is located in (e.g., user location), a username, reasons for joining the application, other personal identification information and the like. Once a user has created a profile, the operation of the system is run as illustrated in the flowcharts in FIGS. 3 and 4, and as described further below.

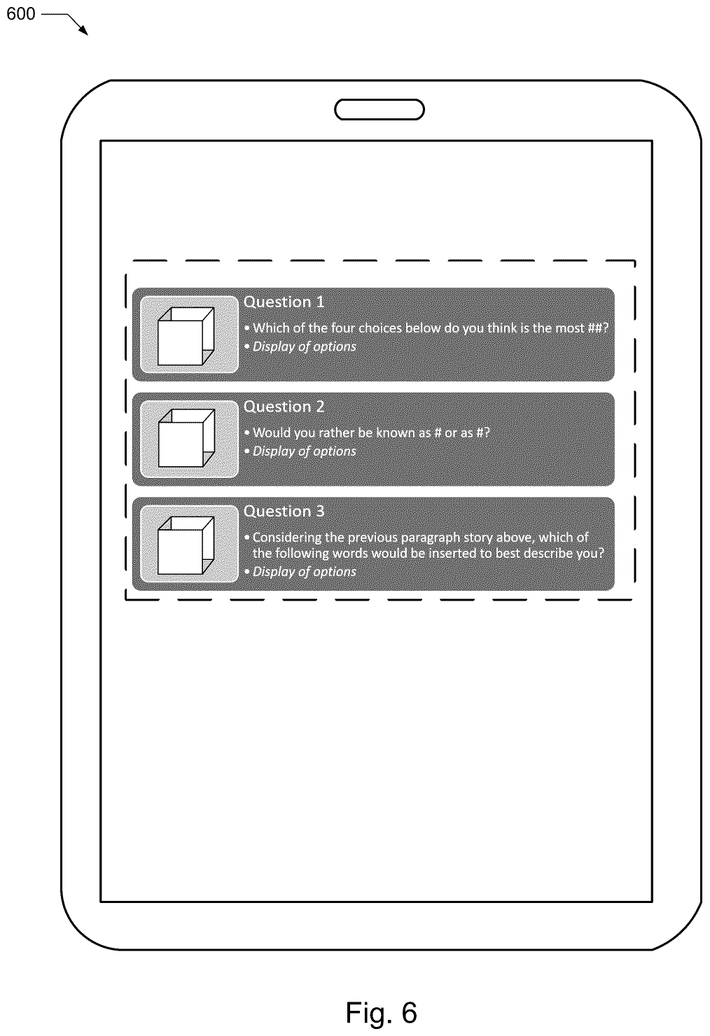

FIG. 3 illustrates a proposed flowchart 300 showing operation of the system 102 of FIG. 1. In particular, FIG. 3 shows a computer-implemented method for facilitating social activity. The user may choose between a plurality of modules to join or participate in. Once selected, the operation includes providing a first set of questions to a user based on a selected module through a graphical user interface (GUI) (Block 302) as illustrated in FIG. 6.

FIG. 6 illustrates a screenshot of a first set of questions on a mobile device in accordance with an embodiment of the disclosed system. For example, the screenshot of the first set of questions 600 includes 3 questions. However, it should be noted that the first set of questions is not limited to only 3 questions and the first set of questions can be any number of questions.

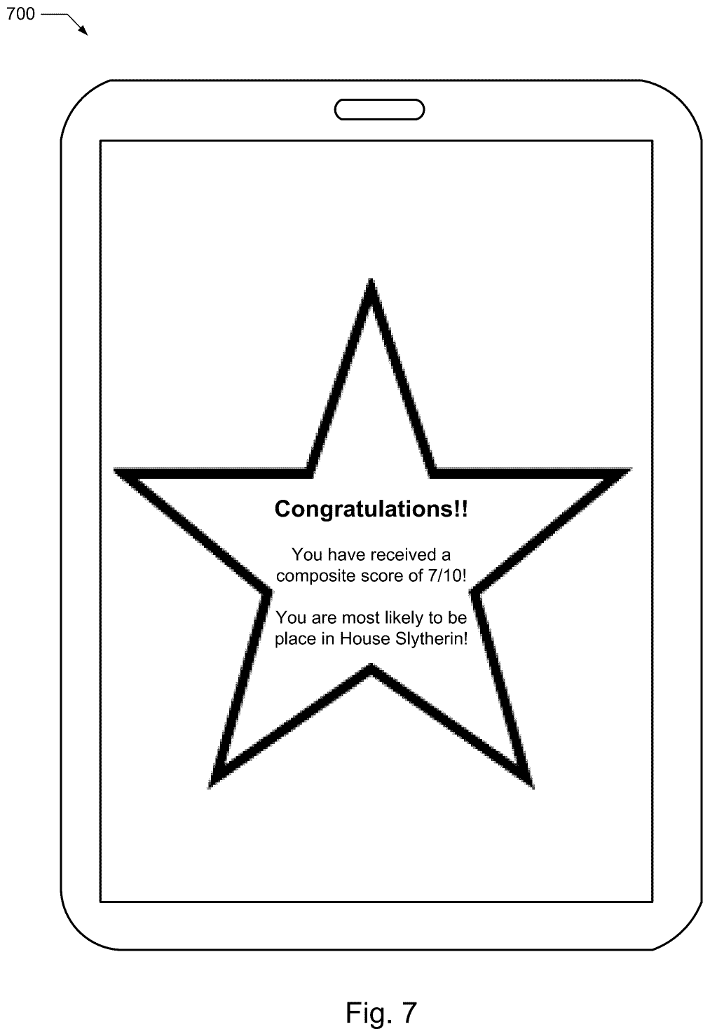

Referring back to FIG. 3, the operation further includes receiving responses to the first set of questions from the user through the GUI (Block 304). The operation also includes calculating a score for the user based on the received responses and generating a personality type for the user based on the calculated score (Block 306). The operation further includes providing the calculated score and the generated personality type to the user through the GUI (Block 307). The calculated score and generated personality type is displayed to the user, as illustrated in FIG. 7. For example, FIG. 7 illustrates a screenshot of a notification screen 700 for a mobile device notifying a user of their calculated score and personality type according to an embodiment of the disclosed system. FIG. 7 displays the calculated score and personality type based on a selected module. In the example shown in FIG. 7, the user received a composite score of 7/10 and a personality type of “House Slytherin” for a Harry Potter themed module.

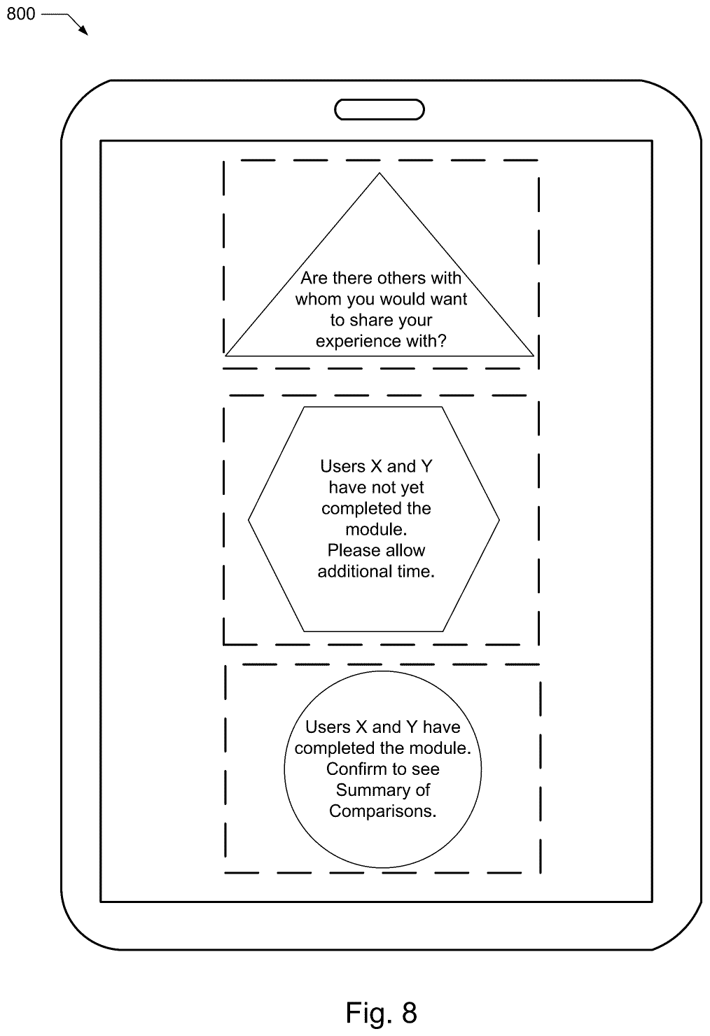

Referring back to FIG. 3, as the user completes the module, the operation includes prompting at least one message to the user to facilitate insight on the provided calculated score and personality type through the GUI (Block 320), as shown in FIG. 8. FIG. 8 illustrates another screenshot of a notification screen 800 for a mobile device in accordance with an embodiment of the disclosed system. As illustrated in FIG. 8, the system may then facilitate insight on the provided calculated score and personality type from FIG. 7 by prompting User X in a number of ways. For example, the notification screen 800 may ask users whether they are ready to share their experiences (i.e., invite others or share its score with an already participating user), notify users of their pace in completing each module, and ask the users to confirm whether the users are ready to see their “Summary of Comparisons.” In other words, the notification screen 800 is used to facilitate insight and update the one or more users on their progress through at least one message.

Furthermore, there may be a first message and a second message of the at least one message, as illustrated in FIG. 10. FIG. 10 illustrates a screenshot of a summary provided to a plurality of users on a mobile device in accordance with an embodiment of the disclosed system. The summary screen 1000 displays the similarities, differences, and facilitates further insight. The first message of FIG. 10 relates to the responses to the first set of questions, the calculated score based on the first set of questions, and the generated personality type. The first message also provides the user of the one or more users information regarding what each score and personality type mean. The second message relates to a transmitted summary and highlights similarities in the transmitted summary (described further below). The summary may facilitate insight by providing an analysis of how and why each user received their respective scores. The analysis is based on how each question from the set of questions was answered by each respective user. By providing an analysis that explains what question(s) weighed favorably in deciding a personality type for that user, and why that user's answer to that question did not fit with other possible personality types, insight is provided to the users.

In addition, the summary contains information about the user compared to other users who have completed the same first set of questions. In other words, the summary may contain a percentage of users who answered the first set of questions the same way, or a percentage of users who received the same personality trait from completing the same first set of questions. Furthermore, at least one message may provide the user of the one or more users: the responses to the first set of questions; the calculated score based on the first set of questions; the generated personality type; the information regarding what each score and personality type mean; and the transmitted summary. Thus, one message may be prompted instead of multiple separate messages.

For example, the disclosed system/application provides a first set (e.g., series) of questions to a User X (e.g., theme), and receives the responses to the first set of questions from the User X through the GUI. The first set of questions is created to break the ice and create a fun and safe environment for User X. The responses to the first set of questions generate a score and personality type of User X to help User X determine which of the identified personalities or types User X matches to. Through the GUI, the system may then facilitate insight on the provided calculated score and personality type by prompting User X in a number of ways, as described herein, thus allowing User X to better understand who they are. Insight may be facilitated through the messages provided to the user of the one or more users by the GUI or display.

In other words, the series of questions may pertain to different subjects, such as TV shows, movies, politics, astrology/zodiac signs, etc., based on the selected module. The selected module may pertain to any topic such as politics, anatomy, pop culture, and the like. The user may or may not have any prior knowledge of any of these subjects, but based on their answers to the series of questions, the user is provided with a result (e.g., “your zodiac sign is Aries,” “the character of the TV show Riverdale that you relate most to is Archie Andrews,” “your political affiliation is mostly democratic,” and the like). The result may or may not align with what the user may have previously considered themselves to be, which can be a fun and new learning experience in and of itself.

In one example, as illustrated in FIG. 10, Users X, Y, and Z decide to complete a module to determine what kind of leadership traits they possess. There are four possible leadership traits that Users X, Y and Z, can be. The four traits are “Weight Carrier,” “Deflector,” “Shrugger,” and “Anarchist.” For example, Users X and Y both answered Question 4 that they prefer to take on issues directly. This scored heavily into their final score and indicated them as “Weight Carriers.” User Z answered Question 4 that it “prefers to hand its problems over to someone else.” That answer eliminated the possibility of User Z being scored as a “Weight Carrier.” However, all three of the Users X, Y, and Z answered Question 5 in that they “prefer to see a problem reach a resolution and prefer to follow up.” This is important because if User Z would have answered Question 5 that it doesn't really care how the problem is resolved, then that answer would have scored User Z as a “Shrugger.” Thus, even though User Z scored differently than Users X and Y in the end, all have a shared trait of wanting to see problems through to the end and wanting resolution. This added feedback, or insight, provided to the users of the disclosed system provides an improvement over conventional methods because the application recognizes commonality or, at minimum, means for conversation beyond a performative or arbitrary method. The application does not assume that only those that score exactly the same on all answers should be ‘matched’ (i.e., linked for further conversation). The application also goes further than conventional methods which fail to recognize that responding differently to various scenarios may still be interesting and in fact constructive for a plurality of users because such recognized differences may give more insight into different backgrounds or cultural and situational appreciations. By doing so, the application removes an inherent or assumed prejudice against things that are different; rather, it encourages users to go beyond the value of one data point so that each user may consider that same point in the context of the larger and complex individual profile.

In another embodiment, the operation may include a plurality of users. As mentioned above, the operation includes: providing a first set of questions to a user of one or more users based on a selected module through a graphical user interface (GUI) (Block 302); receiving responses to the first set of questions from the user of the one or more users through the GUI (Block 304); and calculating a score for the user of the one or more users based on the received responses and generating a personality type for the user of the one or more users based on the calculated score (Block 306). Additionally, the operation includes comparing the calculated score, the generated personality type, and the responses to the first set of questions between a plurality of users (Block 308). In other words, the calculated score, the generated personality type, and the responses to the first set of questions of the of the one more users is compared to another user's respective calculated score, generated personality type, and responses to the first set of questions as further illustrated in FIG. 10.

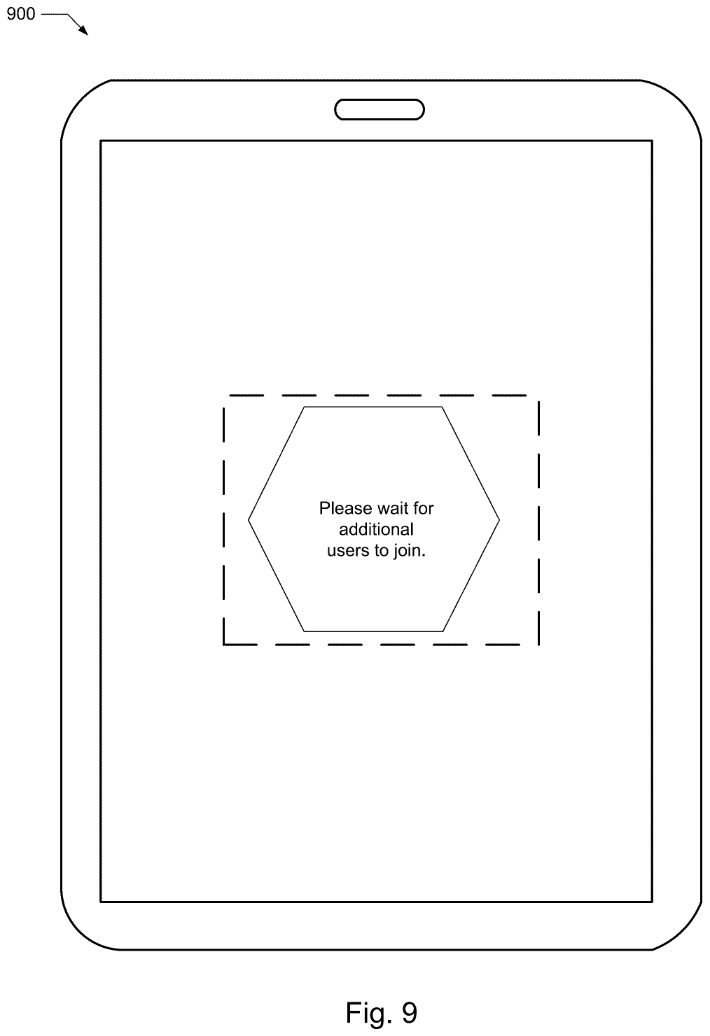

For example, User X wants to invite her friend User Y to participate in a module. User X invites User Y, using the GUI, to answer a first set of questions from the selected module. Once User Y accepts to join and participate in the selected module, the disclosed system/application will prompt both User X and User Y to wait while others join, as illustrated in FIG. 9.

FIG. 9 illustrates another screenshot of a notification screen 900 for a mobile device notifying users to wait for other additional users to join in accordance with an embodiment of the disclosed system. As illustrated in FIG. 9, the system prompts both User X and User Y to wait while another user may join. In order to sponsor simultaneous play, the disclosed system/application will ‘open’ the module at the same time for each user participating, such that the questions to the first set of questions are completed in real-time (e.g., simultaneously).

The method further includes generating a summary of the comparisons of the respective scores, personality types, and responses based on the first set of questions between the user and the other user of the one or more users (Block 310). The summary may contain descriptive information about each user and who each user really is as shown in example FIG. 10. As mentioned above the summary may provide an analysis that explains what question(s) weighed favorably in deciding a personality type for that user, and why that user's answer to that question did not fit with other possible personality types, thus providing insight to the user or users.

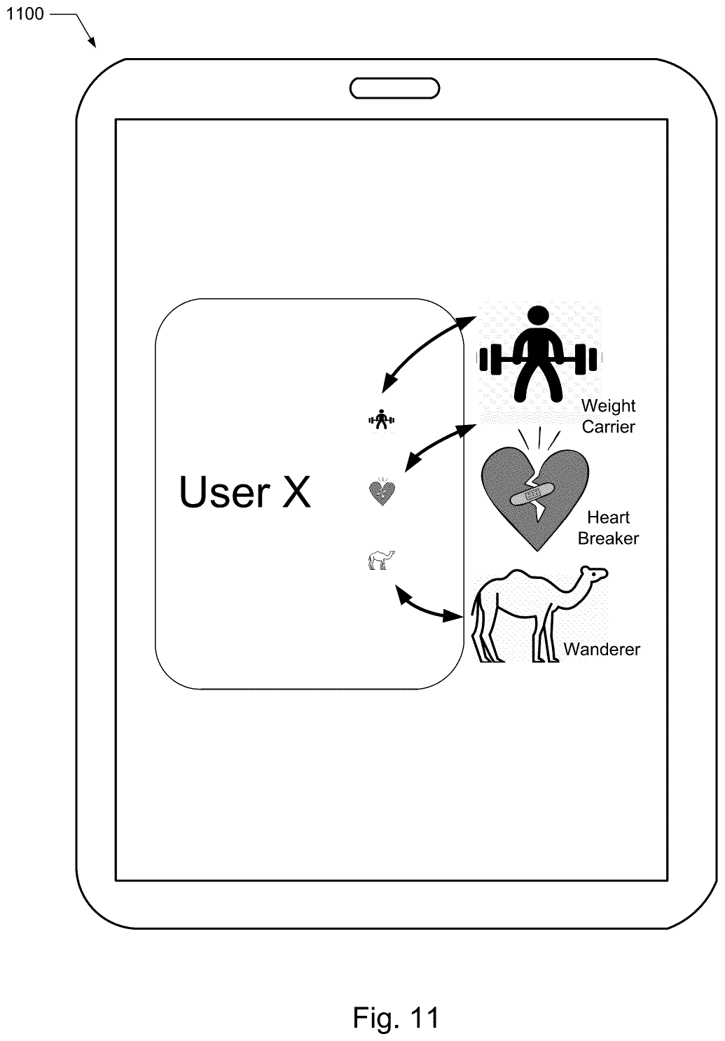

The method further includes generating one or more badges associated with each respective user profile (Block 312). The badges may be used as accomplishments or achievements for a module a user has completed, as illustrated in FIG. 11. FIG. 11 illustrates a screenshot 1100 of one or more badges associated with the user profile. As mentioned above, each of the one or more badges is related to: the responses to the first set of questions; the calculated score based on the first set of questions; the generated personality type based on the first set of questions; or a combination thereof. The badges may be used as another avenue to facilitate insight into who the user is. For example, after completion of every module, User X receives a badge stored under its user profile as described herein. The results corresponding to each of the completed modules by User X are stored under each corresponding badge. Referring to FIG. 11, User X completed three different modules: a leadership module, a relationship module, and a traveling module. A badge is displayed for each module depicting the score relating to that respective module. User X has a “Weight Carrier” badge, a “Heart Breaker” badge, and a “Wanderer” badge. Thus, the badges create a history of the user's progress, further facilitating a deeper understanding of who the user is and how and why the user received each score and personality type for each module the user completed. Furthermore, each of the stored badges may be compared with other users' badges to determine, match, and create strong connections (e.g., a connection with frequent similarities). User Y may match and connect with User X and view User X's profile to determine who User X is. User Y and X may further compare badges and discuss their results, creating yet another avenue to gain a deeper understanding of each other.

The method may further include storing the summary and the badges under each respective user profile to each respective user (Block 314); and transmitting each respective user's summary to the other respective users (Block 316). Thus, each summary may be a small insight on who a user is. As mentioned above, each user profile contains private and/or public information pertaining to that user. Each badge contains information pertaining to each module that was completed by that respective user.

For example, User X has completed a module about politics. User X has received its score, personality type, and responses to a first set of questions from the selected module about politics. User X invites User Y to participate in the same module. User Y completes the same module as User X about politics. The system 102 may compare the calculated score and the generated personality type of User X for the selected module with User Y's calculated score and generated personality type. A summary is generated by the system 102. The summary is the comparisons of the respective scores, personality types, and responses based on the first set of questions about politics between User X and User Y and/or the general population that has completed the same first set of questions. As mentioned above, the summary may provide an analysis that explains what question(s) weighed favorably in deciding a personality type for that user, and why that user's answer to that question did not fit with other possible personality types, thus providing insight to the user or users. The summary is transmitted to both User X and User Y and is also stored under each respective user in the user dataset 108.

The operation may further include initiating (i.e., generating) a communication session between the user and the other user of the one or more users (Block 318). The communication session allows for interaction between the user and the other user. For example, User X and User Y may not be able to discuss their similarities and differences in person, so the system 102 may initiate a communication session. The communication session allows for interaction between User X and User Y. Such a communication session may be implemented via a wired and/or wireless electronic communications network, such as the wide area network 136, local area network 134, and/or radio 140, in a network environment 100.

Additionally, after a communication session has been initiated (Block 318), as mentioned above, a notification generator 123 prompts at least one message to the one or more users to facilitate insight on the provided calculated composite scores and personality types through the GUI (Block 320). There may be provided a first message and a second message of the at least one message. Referring to FIG. 10, the first message may relate to the responses to the first set of questions, the calculated composite score based on the first set of questions, and the generated personality type. The first message may also provide the user of the one or more users information regarding what each score and personality type mean. The second message may relate to a transmitted summary and may highlight similarities in the transmitted summary. Furthermore, as mentioned above, multiple separate messages may be combined into one message.

For example, once Users X and Y receive the transmitted summary, the system 102 displays a first and second message through the GUI. The first message provides both Users X and Y with a description of what their respective scores and personality types mean. In other words, User X may receive a personality type of “perfectionist.” The first message may explain what a “perfectionist” is and describe the pros and cons of a person with that personality type. On the other hand, the second message highlights the similarities and differences, described in the summary, between Users X and Y. In other words, the second message may display that User X and User Y received the same answer for Questions 1-10. Likewise, the second message may display that 0 questions were answered the same way between Users X and Y. Furthermore, the second message may display what questions weighed favorably in deciding Users X's and Y's personality types and why those questions are so important. This type of insight into a user's own summary as compared to others provides an opportunity for different users to connect with each other in a deeper and more meaningful way, as opposed to two users simply acknowledging that they are both “perfectionists.”

In another embodiment, the operation may further include a second set of questions to the user of the one or more users through the GUI (Block 319). The second set of questions is related to the received responses to the first set of questions. Furthermore, the communication session is prompted by the second set of questions to help the user and the other user of the one or more users to understand the respective composite scores, personality types, and responses to the first set of questions, while the communication session is performed in real-time. For example, User X and User Y may be prompted by a second set of questions to further help User X and Y understand their differences and similarities. The second set of questions may encourage further discussion between Users X and Y by helping the users dive deeper into why each of them answered the questions the way they did. The second set of questions may contain questions such as: “Why is User X's Answers to the first set of questions different from User Y's answers;” “Is there a past experience that has impacted User X to answer the first set of questions the way they did;” “Is there a past experience that has impacted User Y to answer the first set of questions the way they did;” and the like.

FIG. 4 illustrates another embodiment of a proposed flowchart showing operation of the system 102 of FIG. 1. In particular, FIG. 4 shows another embodiment of the computer-implemented method for facilitating social activity. The operation includes providing a first set of questions (Block 402) as shown in example FIG. 6. The operation further includes: receiving responses to the first set of questions (Block 404); and calculating a score based on the received responses, and generating a personality type based on the received responses (Block 406). The operation further includes generating one or more badges associated with a user profile (Block 408) as shown in FIG. 11; and storing the user profile associated with the user of the one or more users in the user dataset 108 (Block 410). The user profile includes the responses to the first set of questions from the user, the calculated score for the user, and the generated personality type for the user. Each first set of questions is from a selected module, which is based on a theme.

The operation 400 further includes comparing the calculated score, the generated personality type, and the responses to the first set of questions between a plurality of users (Block 411). In other words, the calculated score, the generated personality type, and the responses to the first set of questions of the one or more users is compared to another user's respective calculated composite score, generated personality type, and responses to the first set of questions.

The operation 400 further includes matching the user profile with another user profile (Block 412), and prompting the user of the one or more users to share and compare the stored user profile with a respective user of the matched at least one other user profile (Block 414). In other words, matched users may be prompted to share and compare their stored user profiles over any type of medium as shown in example FIG. 8. Such medium may include a smartphone, a computer, a cell phone, in-person, or the like. The operation 400 further includes initiating a communication session (Block 416), and prompting at least one message to the one or more users to facilitate insight on the provided calculated score and personality type through the GUI (Block 418). In other words, the at least one message may be a text message, an audio message, or the like.

The communication session initiated (Block 416) allows for interaction between the user and the other user. The communication session may be implemented through online messaging, e-mailing, phone calls, or the like.

In another embodiment, a second set of questions may be provided (Block 419) to help facialite the initiated communication session. As mentioned above, the second set of questions may be related to the received responses to the first set of questions. The communication session may be prompted by the second set of questions to help the user and the other user of the one or more users to understand the respective scores, personality types, and responses to the first set of questions.

The at least one messages (Block 418) may include a first message and a second message as shown in example FIG. 10. The first message may relate to the responses to the first set of questions, the calculated composite score based on the first set of questions, and the generated personality type. The first message also provides the user of the one or more users information regarding what each composite score and personality type mean. The second message may relate to a transmitted summary and highlights similarities in the transmitted summary. The summary may contain an analysis that explains what question(s) weighed favorably in deciding a personality type for that user, and why that user's answer to that question did not fit with other possible personality types, thus providing insight on who the user or users are. For example, the summary may state:
X and Y-you both answered Question 4 that you prefer to take on issues directly. This scored heavily into your final score and indication as a “Weight Carrier.” Z-You answered Question 4 that you prefer to hand your problems over to someone else; that answer eliminated the possibility of you being scored as a “Weight Carrier.” BUT WAIT! All three of you answered the following Question 5 that you prefer to see a problem reach resolution and prefer to follow up. This is important because if you [User Z] had answered Question 5 that you “don't really care how it is resolved,” then that answer would have scored you as a “Shrugger.” So, you see that-even though you scored differently in the end-you all have a shared trait of wanting to see problems through to the end and wanting resolution.

In another embodiment, the summary may contain information about the user compared to other users who have completed the same first set of questions. In other words, the summary may contain a percentage of users who answered the first set of questions the same way, or a percentage of users who received the same personality trait from completing the same first set of questions.

For example, User X has completed a first set of questions on its own based on a chosen module. User X receives its results which may or may not align with what User X may have previously thought of themselves or considered themselves to be, which can be a fun and new learning experience in and of itself. After completion of every module, User X receives a badge stored under its user profile. The results corresponding to each of the completed modules by User X are stored under each corresponding badge. The disclosed system/application may now compare User X's badges, scores, personality types, and responses with other users to determine potential connections based on the results provided from each completed module and provide User X with further information when compared against a larger community (e.g., statistics of the personality type of the user and the like).

The disclosed system/application may then match or connect users based on the results from the series of questions provided. The disclosed system/application may match users with similar results and create a communication session between the matched users. The matched users may connect with other users who obtain the same results (e.g., answers from the set of questions, composite scores, personality types, and the like). Thus, users with similar personality types based on a module may be matched together to initiate a conversation through a communication session.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, which are intended to define the spirit and scope of this invention.

1. A computer implemented method of facilitating social activity, the computer implemented method comprising:
providing, by a processor through a graphical user interface (GUI), a first set of questions to a user of one or more users based on a selected module, the first set of questions provided to the user of the one or more users;
receiving, by the processor through the GUI, responses to the first set of questions from the user of the one or more users;
calculating, by the processor, a composite score for the user of the one or more users based on the received responses;
generating, by the processor, a personality type for the user of the one or more users based on the calculated composite score;
providing, by the processor through the GUI, the calculated composite score and the generated personality type to the user of the one or more users; and
prompting, by the processor, at least one message to the one or more users for developing content-rich conversations between the one or more users.

2. The method of claim 1, further comprising:
comparing, by the processor, the calculated composite score and the generated personality type of the user with a composite score and a personality type of another user of the one more users, the composite score and the personality type of the other user being calculated and generated based on responses by the other user to the first set of questions;
comparing, by the processor, the responses to the first set of questions between the user and the other user of the one or more users;
generating, by the processor, a summary of the comparisons of the respective composite scores, personality types, and responses based on the first set of questions between the user and the other user of the one or more users;
transmitting, by the processor, the summary to the user and the other user of the one or more users; and
storing, by the processor, the transmitted summary to a database, the transmitted summary being associated with the user and the other user of the one or more users.

3. The method of claim 2, further comprising:
displaying, by the GUI, a first message and a second message to the user of the one or more users,
wherein the first message relates to the responses to the first set of questions, the calculated composite score based on the first set of questions, and the generated personality type, and wherein the first message provides the user of the one or more users information regarding what each composite score and personality type mean, and
wherein the second message relates to the transmitted summary and highlights similarities in the transmitted summary.

4. The method of claim 3, further comprising:
initiating, by the processor, a communication session between the user and the other user of the one or more users, wherein the communication session allows for interaction between the user and the other user.

5. The method of claim 4, wherein the communication session is performed in real-time.

6. The method of claim 4, further comprising:
providing, by the processor, a second set of questions to the user of the one or more users, the second set of questions being related to the received responses to the first set of questions,
wherein the communication session is prompted by the second set of questions to help the user and the other user of the one or more users to understand the respective scores, personality types, and responses to the first set of questions.

7. The method of claim 1, further comprising:
storing, in a database by the processor, a user profile associated with the user of the one or more users, the user profile including the responses to the first set of questions from the user, the calculated composite score for the user, and the generated personality type for the user; and
matching, by the processor, the user profile with at least one other user profile stored in the database.

8. The method of claim 7, further comprising prompting, by the processor, the user of the one or more users to share and compare the stored user profile with a respective user of the matched at least one other user profile.

9. The method of claim 7, further comprising:
generating, by the processor, one or more badges associated with the user profile; and
storing, by the processor, the one or more badges associated with the user profile, wherein each of the one or more badges is related to:
the responses to the first set of questions;
the calculated composite score based on the first set of questions;
the generated personality type based on the first set of questions; or
a combination thereof.

10. The method of claim 1, wherein the selectable module is based on a theme.

11. A system for facilitating social activity, the system comprising:
a graphical user interface (GUI) for visually interacting with a user of one or more users;
a data preparer configured to provide, through the GUI, a first set of questions to the user of the one or more users based on a selected module, and receive responses, through the GUI, to the first set of questions from the user of the one or more users;
a data analyzer configured to calculate a composite score for the user of the one or more users based on the received responses, generate a personality type for the user of the one or more users based on the calculated composite score, and provide, through the GUI, the calculated composite score and the generated personality type to the user of the one or more users; and
a notification generator configured to generate at least one message for prompting content-rich conversations.

12. The system of claim 11, wherein the data analyzer is further configured to:
compare the calculated composite score and the generated personality type of the user with a composite score and a personality type of another user of the one more users, the composite score and the personality type of the other user being calculated and generated based on responses by the other user to the first set of questions;
compare the responses to the first set of questions between the user and the other user; and
generate a summary of the comparisons of the respective composite scores, personality types, and responses based on the first set of questions between the user and the other user of the one or more users.

13. The system of claim 12, further comprising:
a transmitter configured to transmit the summary to the user and the other user of the one or more users; and
a database configured to store the transmitted summary, wherein the transmitted summary is associated with the user and the other user of the one or more users.

14. The system of claim 12, further comprising a communication generator configured to generate a communication session between the user and the other user of the one or more users, wherein the communication session allows for interaction between the user and the other user in real-time.

15. The system of claim 14, wherein the data preparer is further configured to provide a second set of questions to the user of the one or more users, the second set of questions being related to the received responses to the first set of questions,
wherein the communication session is prompted by the second set of questions to help the user and the other user of the one or more users to understand the respective scores, personality types, and responses to the first set of questions.

16. The system of claim 14, further comprising a database configured to store a user profile associated with the user of the one or more users,
wherein the user profile includes the responses to the first set of questions from the user, the calculated composite score for the user, and the generated personality type for the user, and
wherein the data preparer is further configured to access the user profile stored in the database.

17. The system of claim 16, further comprising:
a match generator configured to match the user profile with at least one other user profile stored in the database.

18. The system of claim 17, wherein the communication generator is further configured to prompt, through the GUI, the user of the one or more users to share and compare the stored user profile with a respective user of the matched at least one other user profile.

19. The system of claim 16, further comprising a badge generator configured to generate one or more badges associated with the user profile and store the one or more badges associated with the user profile, wherein each of the one or more badges is related to:
the responses to the first set of questions;
the calculated composite score based on the first set of questions;
the generated personality type based on the first set of questions; or
a combination thereof.

20. The system of claim 13, wherein the notification generator is configured to display through the GUI a first message and a second message to the user and the other user of the one or more users,
wherein the first message relates to the responses to the first set of questions, the calculated composite score based on the first set of questions, and the generated personality type, and wherein the first message provides the user of the one or more users information regarding what each composite score and personality type mean, and
wherein the second message relates to the transmitted summary and highlights similarities in the transmitted summary.

21. A system for facilitating social activity, the system comprising:
a means for providing a first set of questions to a user of one or more users, the first set of questions being based on a selected module;
a means for receiving responses to the first set of questions from the user of the one or more users;
a means for calculating a composite score for the user of the one or more users based on the received responses;
a means for generating a personality type for the user of the one or more users based on the calculated composite score;
a means for providing the calculated composite score and the generated personality type to the user of the one or more users; and
a means for prompting the one or more users to facilitate insight on the provided calculated composite score and personality type.
